(19) United States
(12) Patent Application Publication
(10) Pub. No.: US 2026/0346444 A1
(43) Pub. Date: Nov. 5, 2026

(54) CONTROL METHOD, CONTROL SYSTEM AND COMPENSATION MODULE OF ROBOTIC ARM

(71) Applicant: TECHMAN ROBOT INC., Taoyuan City (TW)

(72) Inventors: Ching-Wei LEE, Taoyuan City (TW); Chun-Wen LAI, Taoyuan City (TW)

(21) Appl. No.: 19/269,084

(22) Filed: Jul. 15, 2025

(30) Foreign Application Priority Data
Apr. 30, 2025 (TW) 114116353

(51) Int. Cl. B25J 9/16

(52) U.S. Cl. CPC B25J 9/1664

(57) ABSTRACT

A control method of a robotic arm is provided by an aspect of the present disclosure. The control method of the robotic arm includes deploying a reducer including an assembled construction and an angle transmission error (ATE). The control method of the robotic arm includes deploying a control system for controlling the robotic arm according to the assembled construction and the ATE.

This application claims the benefit of Taiwan patent application Serial No. 114116353, filed Apr. 30, 2025, the subject matter of which is incorporated herein by reference.

### TECHNICAL FIELD

The disclosure relates in general to techniques of controlling the robotic arm, and more particularly, to techniques of decreasing motor vibrations in the robotic arm.

### BACKGROUND

Currently, with the development of automated production, the demand for robotic arms has increased. The performance of robotic arms, such as control techniques of robotic arms, has also attracted the attention of various manufacturers. The joint module of a robotic arm is usually composed of a reducer, a motor and a sensor (position and/or speed). However, due to the angular transmission error (ATE) of the reducer, the robotic arm will produce unexpected vibrations during operation, causing resonance of the system, and may affect or damage the grip (or the gripped thing) of the robotic arm. Thus, there are needs for techniques of compensation for controlling the joint module of the robotic arm.

### SUMMARY

According to the control method and compensation module for robotic arm provided by the present disclosure, firstly, the learning controller executes the learning of the angular transmission error (ATE) relationship, and generates the relevant values to form an ATE table stored in the storage circuit of the compensation module. During the compensation control, the ATE table in the storage circuit is used to convert the compensation parameters (such as amplitude and phase). Finally, the amplitude and phase and other information are used to generate compensation control (such as position compensation and/or speed compensation) to compensate the control of the robotic arm.

The first aspect of the present disclosure features a control method of a robotic arm. The control method of the robotic arm includes deploying a reducer including an assembled construction (or assembly mean) and an angle transmission error (ATE). The control method includes deploying a control system for controlling the robotic arm according to the assembled construction (or assembly mean) and the ATE.

The second aspect of the present disclosure features a compensation module. The compensation module includes a storage circuit coupled between a joint module and an amplitude and phase calculation circuit and configured to store an ATE table. The compensation module includes the amplitude and phase calculation circuit coupled between the storage circuit and an error compensation calculation circuit and configured to obtain an amplitude and a phase of a flex spline, and an amplitude and a phase of a circular spline of a reducer. The compensation module includes the error compensation calculation circuit coupled to a position encoder, the storage circuit, the amplitude and phase calculation circuit and a control system and configured to read a motor position and a motor speed of a motor from the position encoder, to obtain a position compensation value according to the ATE table, the amplitude and the phase of the flex spline, and the amplitude and the phase of the circular spline, and the motor position, and obtain a speed compensation value according to the ATE table, the amplitude and the phase of the flex spline, and the amplitude and the phase of the circular spline, the motor position, and the motor speed. The compensation module transmits the position compensation value and the speed compensation value to a control loop of a robotic arm, to compensate for controlling the robotic arm by the joint module.

The third aspect of the present disclosure features a control system of a robotic arm. The control system of a robotic arm includes an assembled construction (or assembly mean), related to a reducer with an ATE. The control system of a robotic arm includes a control loop configured to adjust a control information of the robotic arm according to the assembled construction (or assembly mean) and the ATE of the reducer. A first adjustment is match to a first assembled information to compensate a first ATE coupled to the robotic arm, a second adjustment is match to a second assembled information to compensate a second ATE coupled to the robotic arm.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a function block diagram illustrating an example of robotic arm and control system, according to some implementations of the present disclosure.

FIG. 2 is a diagram illustrating an ATE graph for compensating control, according to some implementations of the present disclosure.

FIG. 3A is a diagram illustrating a cosine signal graph of the flex spline 240 and a sine signal graph of the flex spline 240 for compensating control, according to some implementations of the present disclosure.

FIG. 3B is a diagram illustrating a cosine signal graph of the circular spline 242 and a sine signal graph of the circular spline 242 for compensating control, according to some implementations of the present disclosure.

FIG. 3C is a diagram illustrating an error cosine product signal graph of the flex spline 240 and an error sine product signal graph of the flex spline 240 for compensating control, according to some implementations of the present disclosure.

FIG. 3D is a diagram illustrating an error cosine product signal graph of the circular spline 242 and an error sine product signal graph of the circular spline 242 for compensating control, according to some implementations of the present disclosure.

FIG. 4 is a diagram illustrating a vibration value graph and a torque output graph before and after ATE compensation, according to some implementations of the present disclosure.

FIG. 5 is a flowchart illustrating a procedure for compensating joint module, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

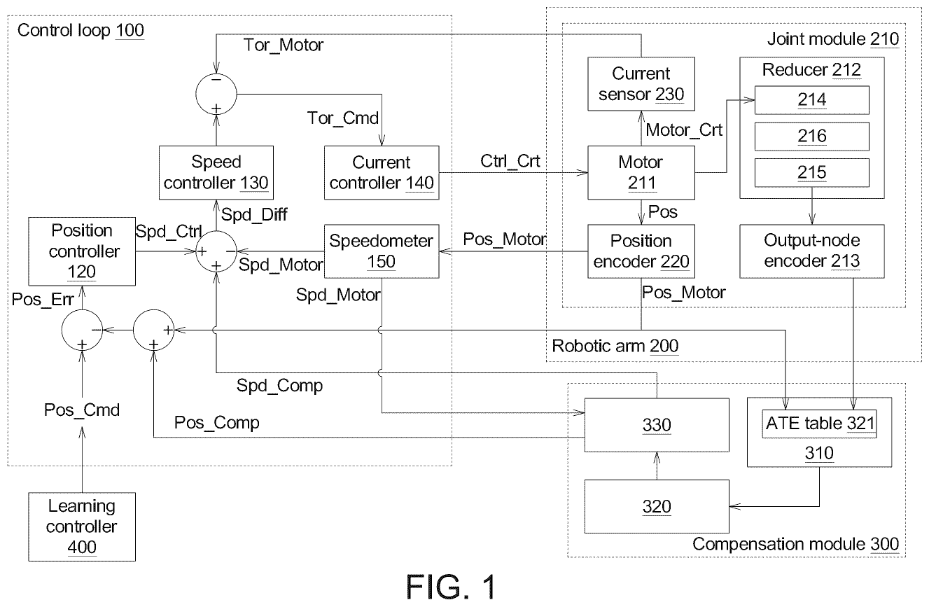

FIG. 1 is a function block diagram illustrating an example of robotic arm 200 and control system (may include control loop 100 and compensation module 300), according to some implementations of the present disclosure. As shown by FIG. 1, the control loop 100 is coupled to the joint module 210 of the robotic arm 200 to control movement states of the robotic arm 200. The joint module 210 includes a motor 211, a position encoder 220 for sensing rotation states (Pos) of the motor 211, a current sensor 230 for sensing the motor current (Motor_Crt) of the motor 211, a reducer 212 coupled to the motor 211, and an output-node encoder 213 for indicating the output position value of the reducer 212. In some implementations, the position encoder 220 and/or the output-node encoder 213 can be optionally an optical encoder which includes various resolutions for indicating how many values (degree) a circle of the encoder can be divided into. For example, a circle can be divided into 100,000 Pulses to represent a circle of 360 degrees.

The reducer 212 may include a wave generator 214, a flex spline 215 and a circular spline 216 for forming different constructions. The wave generator 214 can be formed by integrating a thin ball bearing into the outer ring of an elliptical cam. Although the inner ring of the bearing is fixed on the cam, the outer ring can be elastically deformed through the ball. The wave generator 214 is used as an input (or an input element) of the reducer 212, which is coupled to an output shaft of the motor 211. The flex spline 215 may be formed of a thin cup-shaped elastic metal having a toothed outer ring at its opening and a partition at its bottom (or cup-shaped bottom), so that it can be a first construction (or information) of the reducer 212. The flex spline 215 is used as an output (or an output element) of the reducer 212. The circular spline 216 may be in the form of a rigid ring having teeth cut into the inner ring and fixed to the case of the reducer 212. In some implementations, the number of teeth Zc of the circular spline 216 has two more teeth than the number of teeth Zf of the flex spline 215. For example, the number of teeth Zc of the circular spline 216 is 242 and the number of teeth Zf of the flex spline 215 is 240. For another example, the number of teeth Zc of the circular spline 216 is 202 and the number of teeth Zf of the flex spline 215 is 200. For yet another example, the number of teeth Zc of the circular spline 216 is 162 and the number of teeth Zf of the flex spline 215 is 160.

The number of teeth Zf of the flex spline 215 and the number of teeth Zc of the circular spline 216 would determine the reduction ratio i of the reducer 212, and the assembly mean (for example assembled construction or assembled information) of the wave generator 214, the flex spline 215 and the circular spline 216 would determine the reduction ratio i and the rotation direction of the reducer 212. For example, when Zf is 240 and Zc is 242 while the input (or the input element) is the wave generator 214, the output (or the output element) is the flex spline 215 and the circular spline 216 is fixed, the reduction ratio i is equal to (Zf−Zc)/Zf=(240−242)/240=−1/120. Furthermore, the reduction ratio i is equal to 1/GR (reduction ratio parameter). Therefore, in the above example, the reduction ratio parameter GR is 120, that is, when the motor 211 runs 120 revolutions (to the input node of the reducer 212), the output of the joint module 210 (also the output node of the reducer 212) runs 1 revolution. Similarly, when the motor 211 runs at 120 RPM (to the input node of the reducer 212), the output of the joint module 210 (also the output node of the reducer 212) runs at 1 RPM. Since the reduction ratio i in the above example is −1/120, which is a negative number, it means that Out (output node)=(−1/120) In (input node), that is, the rotation direction of the input node is opposite to the rotation direction of the output node.

Additionally, excepting the assembly mean (or assembled construction) of the reducer 212 with input (or input element) as the wave generator 214, output (or output element) as the flex spline 215 and fixed (or fixed element) as the circular spline 216, the assembly mean of the reducer 212 can also be changed to input as the wave generator 214, output as the circular spline 216 and fixed as the flex spline 215, so that the input (or input node) and output (or output node) are changed to different gear ratios, and then set to different reduction ratios, so that it can be a second construction (or information) of the reducer 212. Regardless of which one of assembly means (or constructions) is used, the rotation state (or input value) received by the reducer 212 and the rotation state (or output value) generated after reduction have an angular transmission error (ATE). Therefore, the control loop 100 (or control system) of the robotic arm 200 generates compensation values (such as position compensation value (Pos_Comp) and/or speed compensation value (Spd_Comp)) according to the assembly mean (or construction) of the reducer 212 to adjust control information (such as control current (Ctrl_Crt) or motor voltage, or etc.) and to change the control of the motor 211 for reducing the vibration of the robotic arm 200 and improving the performance and accuracy of the robotic arm 200.

The control loop 100 is coupled to the robotic arm 200 for controlling the movement of the robotic arm 200. The control loop 100 is coupled to the compensation module 300 for obtaining the motion state of the robotic arm 200 via the compensation module 300. The control loop 100 may be a part of a circuit in an electric control box outside the robotic arm 200, or a part of a circuit in a carrier device such as an autonomous mobile device (AMR) or a guided mobile device (AGC). The control loop 100 includes the position controller 120 coupled to the position encoder 220 of the robotic arm 200. The position controller 120 receives a position absolute difference Pos_Err between a position command Pos_Cmd and a motor position Pos_Motor (or a sum of the motor position Pos_Motor and a position compensation value Pos_Comp) provided by the position encoder 220, wherein a plurality of operators (such as an adder or a subtractor) is coupled between the position controller 120 and the position encoder 220. The position absolute difference Pos_Err can be calculated by the adder according to the position command Pos_Cmd and the motor position Pos_Motor (or the sum of the motor position Pos_Motor and the position compensation value Pos_Comp), as shown in FIG. 1. The position command Pos_Cmd is a command for controlling the motion position of the robotic arm 200, which is a command for controlling the rotation position of the motor 211 of the joint module 210; and the motor position Pos_Motor is the rotation state Pos of the joint module 210 read by the position encoder 220, which represents the actual rotation position of the motor 211 and is related to the actual motion position of the robotic arm 200. In other words, the joint module 210 is the driver of the robotic arm 200, and the position controller 120 provides a speed control Spd_Ctrl according to the absolute position difference Pos_Err, so that the joint module 210 can adjust the control of the robotic arm 200.

The control loop 100 also includes the speedometer 150 coupled to the speed controller 130 and the position encoder 220 of the robotic arm 20. The speedometer 150 generates a motor speed Spd_Motor according to the motor position Pos_Motor received from the position encoder 220, for example, by filtering the motor position differential to obtain the motor speed Spd_Motor. The speedometer 150 provides the motor speed Spd_Motor to the compensation module 300, such as to an error compensation calculation circuit 330 of the compensation module 300.

The speed controller 130 of the control loop 100 is coupled to the position controller 120 and the speedometer 150. The speed controller 130 generates a torque command Tor_Cmd for adjusting the control (or driving) information of the joint module 210 according to the speed absolute difference Spd_Diff obtained by the adder through the motor speed Spd_Motor generated by the speedometer 150 and the speed control Spd_Ctrl generated by the position controller 120 (or adding the speed compensation value Spd_Comp provided by the compensation module 300).

The control loop 100 also includes a current controller 140 coupled to the motor 211 of the joint module 210 and coupled to the speed controller 130 and the current sensor 230 via an arithmetic device (such as an adder). Therefore, the current controller 140 provides driving information to the robotic arm 200 according to the torque command Tor_Cmd (obtained by subtracting the motor current Motor_Crt sensed by the current sensor 230 from the output of the speed controller 130). That is, a control current Ctrl_Crt is provided to the joint module 210 of the robotic arm 200 to control the rotation state of the joint module 210, such as the rotation state Pos of the motor 211.

As discussed as above, since there is an angle transmission error (ATE) between the motor rotation information obtained by the reducer 212 at the input node and the arm operation information generated at the output node after conversion, the compensation module 300 provided by the present disclosure, is coupled to the control loop 100 and the joint module 210, to compensate for the ATE caused by the reducer 212. The motor rotation information is, for example, the motor rotation state Pos, the rotation position of the motor 211 &etc., and the arm operation information is, for example, information for controlling the operation of the robotic arm 200. The compensation module 300 includes a storage circuit 310 coupled to the amplitude and phase calculation circuit 320, and includes the amplitude and phase calculation circuit 320 coupled to the error compensation calculation circuit 330, and includes the error compensation calculation circuit 330 coupled to the speed controller 130 via an adder. The storage circuit 310 is used for storing and ATE table, such as the ATE table 321. The ATE table 321 is generated from summing information relating to the reducer 212 up in advance by the learning controller 400 coupled to the control loop 100 and the joint module 210. Thus, the ATE table 321 has a connection with the learning controller 400.

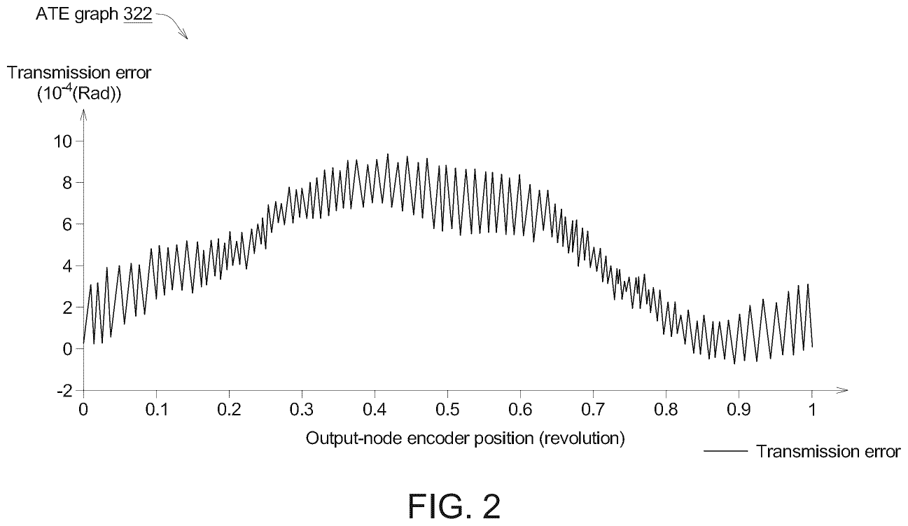

In some implementations, the learning controller 400 receives the number of teeth Zf of the flex spline 215 and the number of teeth Zc of the circular spline 216 (such as read by coupling to the joint module 210 or input by user) to obtain the reduction ratio i of the reducer 212 of the joint module 210, such as the reduction ratio i is equal to (Zf−Zc)/Zf=1/GR as discussed above. Then, the learning controller 400 resets a count of a counter and sets the rotation state of the joint module 210 as the original position, such as by inputting the position command Pos_Cmd to the control loop 100, as shown in FIG. 1. Following, the learning controller 400 calculates a data amount Data_Size related to the reduction ratio I, wherein the data amount is equal to the reduction ratio parameter (GR) multiplied by 360 which can be represented by Data_Size=GR*360. Then, the learning controller 400 moves the motor 211 one (1) degree, for example by inputting the position command Pos_Cmd to the control loop 100, and, after waiting for a preset time, for example three seconds, reads and records the input position value (D_in) of the position encoder 220, for example, the motor position Pos_Motor, and the output position value (D_Out) of the output-node encoder 213. Next, the learning controller 400 increases the count by one and determines whether the count is greater than or equal to the data amount Data_Size. When the count is greater than or equal to the preset data amount Data_Size, the learning controller 400 calculates the compensation value according to the input position value (D_in), the output position value (D_Out) and the reduction ratio i to form an ATE table 321 and store the ATE table 321 in the storage circuit 310 of the compensation module 300. Conversely, when the count is less than the data amount Data_Size, the learning controller 400 repeatedly moves the motor 211 to increase the displacement by one degree, reads and records the input position value (D_in) of the position encoder 220, for example, the motor position Pos_Motor, and the output position value (D_Out) of the output-node encoder 213, after waiting for a preset time, for example, three seconds, and increases the count by one until the count is greater than or equal to the preset data amount Data_Size. Therefore, the ATE table 321 can be generated by the angular transmission accuracy formula: T_err[ ]=D_out[ ]−(D_in[ ]/GR), which represents the difference (T_err[ ]) between the ideal output (D_in[ ]/GR) and the actual output (D_out[ ]) after any angle (from motor) is input to the input node. The ATE table 321 can also be represented by an angular transmission error graph, such as the angular transmission error graph 322 in FIG. 2, which represents the relationship between the output position value (D_Out) of the output-node encoder 213 and the transmission error (T_err[ ]), that is, the transmission error(s) (T_err[ ]) are respectively corresponding to each rotation position. In other words, the rotation position of the output-node encoder 213 and the transmission error of the reducer 212 can correspond to (or find) the actual rotation position of the motor 211, for obtaining the actual control information (or control result).

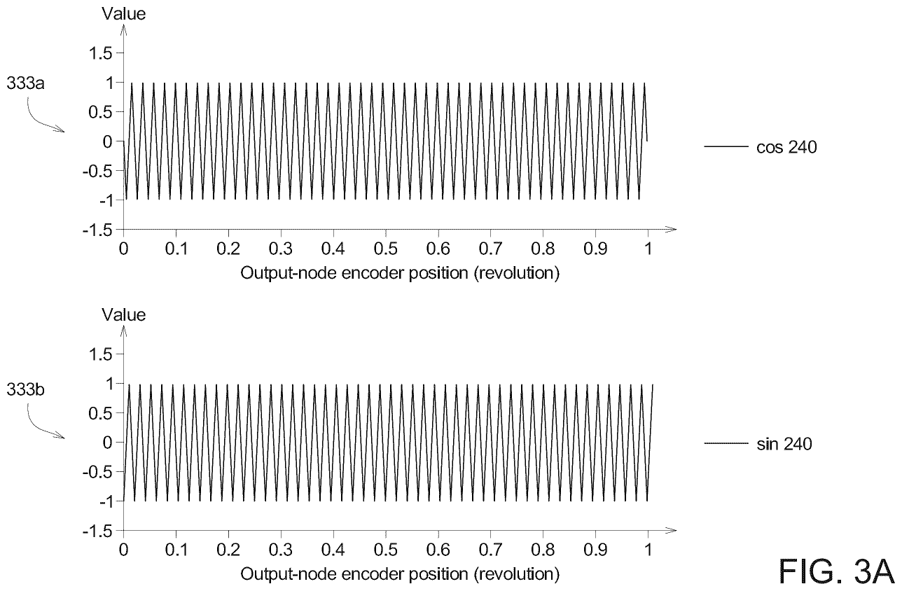

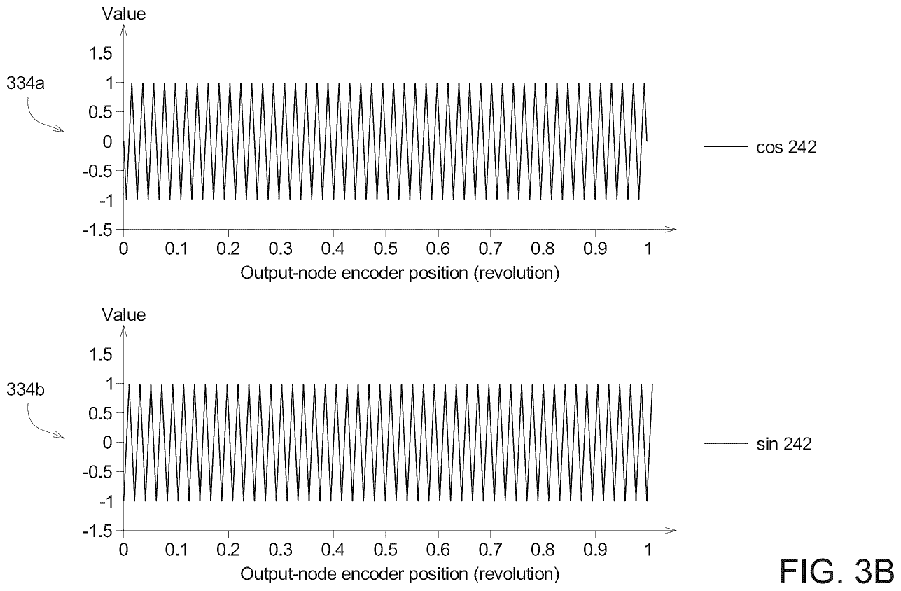

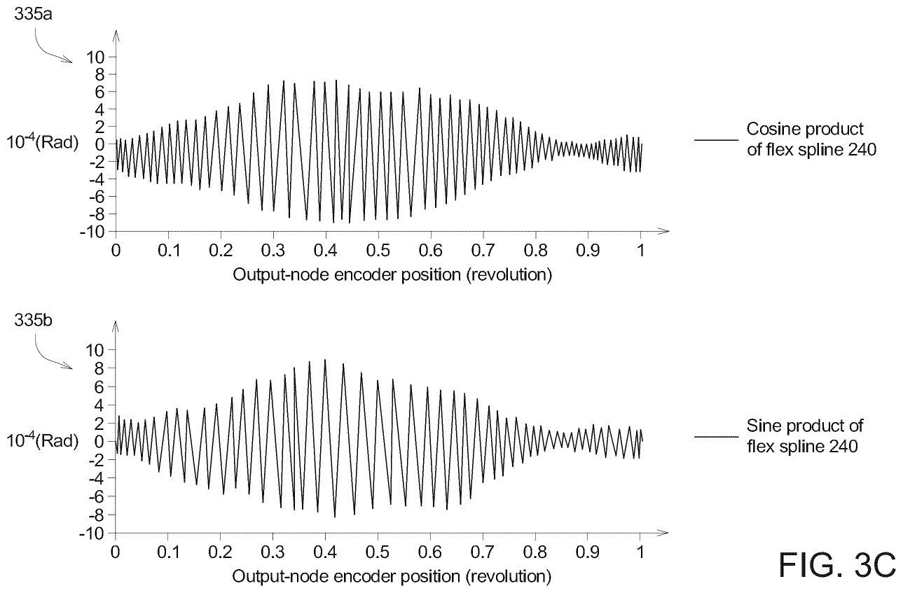

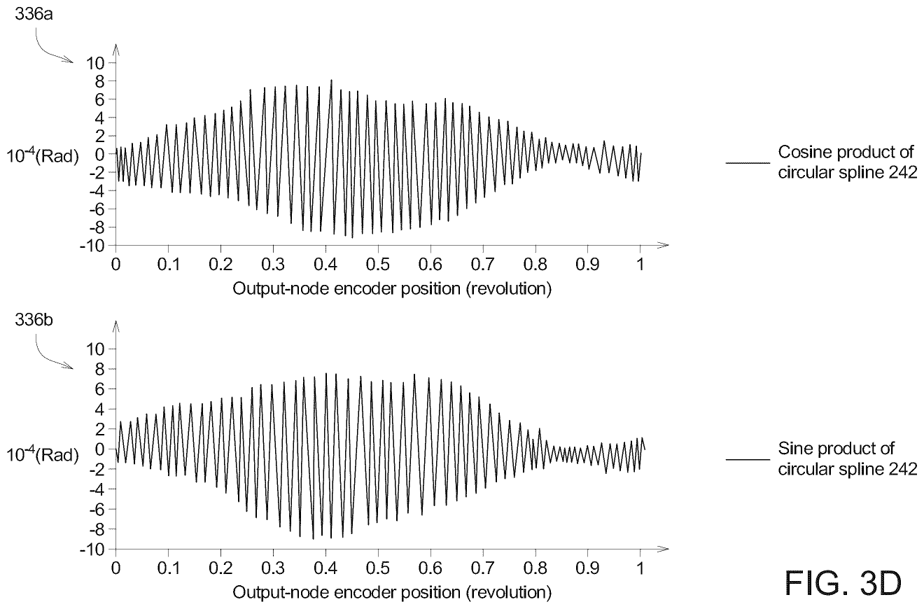

After the storage circuit 310 of the compensation module 300 storing the ATE table 321, the compensation module 300 can compensate the control of the control loop 100 for the joint module 210 according to the ATE table 321. Before performing the compensation, the compensation module 300 needs to obtain compensation parameters. The compensation parameters are related to the amplitude (AMP) and the phase (Phase) of the flex spline 215 and the amplitude (AMP) and the phase (Phase) of the circular spline 216. The compensation parameters are obtained by the amplitude and phase calculation circuit 320 of the compensation module 300 according to the following steps and equations. Firstly, the cosine graph and sine graph of the flex spline 215, and the cosine graph and sine graph of the circular spline 216 are obtained according to the following equations 1 and 2, respectively:

$$cosine graph = cos ( - Index \times 2 \times π \times Z ) \qquad eqution 1$$

$$sine graph = sin ( - Index \times 2 \times π \times Z ) \qquad eqution 2$$

Wherein Z is the number of teeth, such as the number of teeth Zf of the flex spline 215 or the number of teeth Ze of the circular spline 216, and Index is the position index, that is, the equally divided position of the input node (from motor). As mentioned above, the input position value (D_in) of the position encoder 220 is recorded once for each degree of the motor 211, so the position index (Index) represents the positions of the motor 211 at (0 to 360)*GR degrees (output position value (D_out)). The cosine graph and sine graph of the flex spline 215 can refer to the flex spline cosine signal graph 333a and the flex spline sine signal graph 333b of FIG. 3A, wherein the number of teeth Zf of the flex spline 215 is 240 for example, so 240 Hz is used as the cosine and sine signal graph of 1 circle, so as to provide the basis for the subsequent calculation of FIG. 3C. The cosine and sine graphs of the circular spline 216 can be found in the circular spline cosine signal graph 334a and the circular spline sine signal graph 334b in FIG. 3B, wherein the number of teeth Zc of circular spline 216 is 242 as an example, so 242 Hz is used as the cosine and sine signal graphs of 1 circle, which is the basis for the subsequent calculation of FIG. 3D.

Secondly, based on the equation 1 and equation 2, the error cosine product graph and the error sine product graph of the flex spline 215 and the error cosine product graph and the error sine product graph of the circular spline 216 can be respectively obtained according to the following equation 3 and equation 4:

$$eqution 3$$

$$error cosine product graph = cos ( - Index \times 2 \times π \times Z ) \times ATE table ( Index )$$

$$eqution 4$$

$$error sine product graph = sin ( - Index \times 2 \times π \times Z ) \times ATE table ( Index )$$

Wherein, the ATE table is an angular transmission error table, such as the ATE table 321. For example, by multiplying the data of each point on the graph of FIG. 2 with the data of each point on the graph of FIG. 3A, the pre-processing of the inner product vector of the transmission error and the 240 Hz characteristic signal (cosine signal and sine signal) can be calculated, and the error cosine product graph and the error sine product graph of the flex spline 215 can refer to the flex spline error cosine product signal graph 335a and the flex spline error sine product signal graph 335b of FIG. 3C, wherein the number of teeth Zc of the flex spline 215 is 240 as an example. Also, by multiplying the data of each point on the graph of FIG. 2 with the data of each point on the graph of FIG. 3B, the pre-processing of the inner product vector of the transmission error and the 242 Hz characteristic signal (cosine signal and sine signal) can be calculated, and the error cosine product graph and the error sine product graph of the circular spline 216 can refer to the circular spline error cosine product signal graph 336a and the circular spline error sine product signal graph 336b of FIG. 3D, wherein the number of teeth Zc of the circular spline 216 is 242 as an example. In addition, the structure of the circular spline 216 (such as the number of gears Zc) can also be used as a basis for calculation.

Thirdly, based on the equation 3 and equation 4, the error cosine product average value A and the error sine product average value B of the flex spline 215 and the error cosine product average value A and the error sine product average value B of the circular spline 216 can be respectively obtained according to the following equation 5 and equation 6:

$$eqution 5$$

$$error cosine product average value A = 2 \times ( \frac{{\sum }_{Index}^{1} cos ( - Index \times 2 \times π \times Z ) \times ATE table ( Index )}{Times} )$$

$$eqution 6$$

$$error sine product average value B = 2 \times ( \frac{{\sum }_{Index}^{1} sin ( - Index \times 2 \times π \times Z ) \times ATE table ( Index )}{Times} )$$

Wherein, Times is the total count of the position index (Index), which means that, when the output node (for joint) rotates one circle, how many angular transmission error data are recorded. For example, if 1 degree is recorded once, the total count of Times is 360*GR.

Fourthly, based on the error cosine product average value A and the error sine product average value B from the equation 5 and equation 6, the amplitude (AMP) and the phase (Phase) of the flex spine 215, and the amplitude (AMP) and the phase (Phase) of the circular spine 216 can be respectively obtained according to the following equation 7 and equation 8:

$$amplitude ( Amp ) = \sqrt{{A}^{2} + {B}^{2}} \qquad eqution 7$$

$$phase ( Phase ) = {tan}^{- 1} ( \frac{B}{A} ) \qquad eqution 8$$

After the amplitude and phase calculation circuit 320 obtains the compensation parameters (the amplitude (AMP) and phase (Phase) of the flex spline 215, and the amplitude (AMP) and phase (Phase) of the circular spline 216), the error compensation calculation circuit 330 of the compensation module 300 can then calculate the position compensation value Pos_Comp and the speed compensation value Spd_Comp for compensating the control according to the motor position Pos_Motor and the motor speed Spd_Motor using the following equations 9 and 10 respectively:

$$eqution 9$$

$$position compensation value Pos\_Comp = {\sum }_{q = Zf , Zc} {Amp}_{- q} \times cos ( 2 π \times q \times Pos\_Motor + {Phase}_{- q} )$$

$$eqution 10$$

$$speed compensation value Spd\_Comp = {\sum }_{q = Zf , Zc} - 2 π \times q \times {Amp}_{- q} \times sin ( 2 π \times q \times Pos\_Motor + {Phase}_{- q} ) \times ( \frac{Spd\_Motor}{GR} )$$

Wherein, the motor position Pos_Motor and the motor speed Spd_Motor can be provided by the position encoder 220 and the speedometer 150 coupled to the error compensation calculation circuit 330.

Continuing to refer to FIG. 1, the position compensation value Pos_Comp generated by the error compensation calculation circuit 330 of the compensation module 300 can be provided to an adder to obtain the sum of the position compensation value Pos_Comp and the motor position Pos_Motor, so that the position controller 120 can subtract the sum of the position compensation value Pos_Comp and the motor position Pos_Motor from the position command Pos_Cmd through another adder to obtain the position absolute difference Pos_Err provided to the position controller 120. Similarly, the speed compensation value Spd_Comp generated by the error compensation calculation circuit 330 of the compensation module 300 can be provided to the adder, so that the adder outputs the speed absolute difference Spd_Diff to the speed controller 130 according to the speed control Spd_Ctrl, the motor speed Spd_Motor and the speed compensation value Spd_Comp output by the position controller 120, thereby generating a torque command Tor_Cmd to the current controller 140, and outputting a control current Ctrl_Crt to the motor 211 to compensate the operation of the joint module 210.

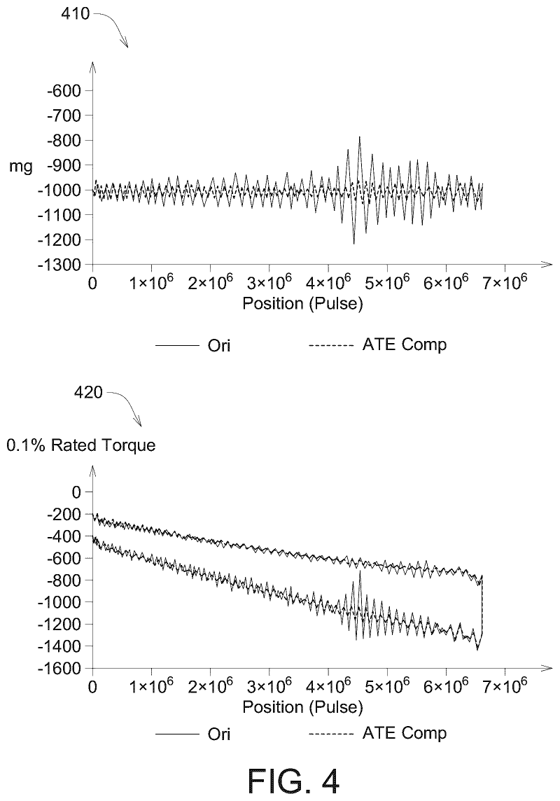

A discussed above, by providing the position compensation value Pos_Comp and the speed compensation value Spd_Comp generated by the error compensation calculation circuit 330 of the compensation module 300 to the control loop 100, compensation control for the joint module of the robotic arm can be provided for the ATE, which can reduce the system resonance, improve the accuracy, performance and reliability of the robotic arm in operation, and avoid the adverse effects or damage of the clamped object of the robotic arm caused by the resonance. The following will refer to FIG. 4 to describe the use of the compensation module 300 according to implementations provided by the present disclosure for the control and improvement of the joint module 210 of the robotic arm 200.

FIG. 4 is a diagram illustrating a vibration value graph 410 and a torque output graph 420 before and after ATE compensation (ATE comp), according to some implementations of the present disclosure. As shown in the vibration value graph 410 of FIG. 4, by using the compensation module 300 to control the joint module using the ATE compensation (ATE comp), the vibration of the joint module 210 can be improved, reduced and stabilized. Similarly, as shown in the torque output graph 420 of FIG. 4, by using the compensation module 300 to provide the ATE compensation (ATE comp) to control the joint module 210, the torque output of the joint module 210 can also be made more stable.

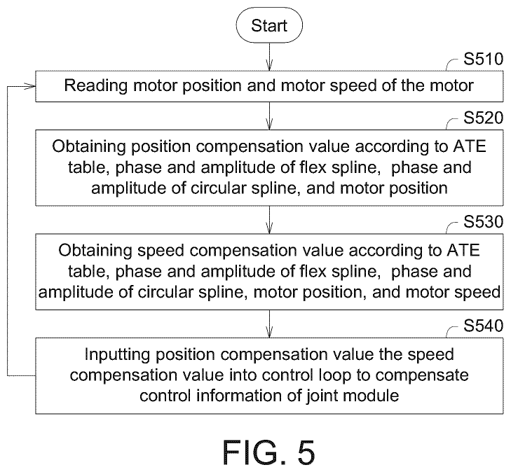

FIG. 5 is a flowchart illustrating a procedure for compensating joint module, according to some implementations of the present disclosure. In step S510, the compensation module 300 reads the motor position Pos_Motor and the motor speed Spd_Motor of the motor 211 from the position encoder 220.

In step S520, the error compensation calculation circuit 330 obtains a position compensation value Pos_Comp (such as by the equations 1-9) according to an ATE table (such as the ATE table 321 stored in the storage circuit 310 of the compensation module 300 in FIG. 1), a phase and an amplitude of a flex spline 215, a phase and an amplitude of a circular spline 216, and the motor position Pos_Motor.

In step S530, the error compensation calculation circuit 330 obtains a speed compensation value Spd_Comp (such as by the equations 1-8 and 10) according to the ATE table 321, a phase and an amplitude of a flex spline 215, a phase and an amplitude of a circular spline 216, the motor position Pos_Motor, and the motor speed Spd_Motor.

In step S540, the compensation module 300 inputs the position compensation value Pos_Comp and the speed compensation value Spd_Comp into the control loop 100 coupled to the joint module 210 to compensate the control information of the joint module 210.

In certain configurations, the joint module 210 includes the output-node encoder 213 coupled to the reducer 212, for indicating an output position value of the joint module 210.

In certain configurations, the ATE table 321 is generated by following steps: reading, by the learning controller 400, some information related to the areduction ratio i of the joint module 210, the number of teeth Zf of the flex spline 215, and the number of teeth Zc of the circular spline 216; resetting, by the learning controller 400, a count of a counter, and setting a rotation status of the joint module 210 to an original position; calculating, by the learning controller 400, a data amount related to the reduction ratio i; moving, by a learning controller 400, 1 degree rotating movement of the motor 211, and, after waiting for a preset time, reading and recording an input position value (D_in) of the position encoder 220 and the output position value (D_Out) of the output-node encoder 213; increasing, by the learning controller 400, the count by 1, and determining whether the count is greater or equal to the data amount related to the reduction ratio i; when the count is greater or equal to the data amount, calculating, by the learning controller 400, the ATE table 321 according to the input position value (D_in), the output position value (D_Out), and the reduction ratio i, and storing the ATE table 321 in the storage circuit 310 of the compensation module 300; or, when the count is less than the data amount, moving, by the learning controller 400, repeatedly 1 degree rotating movement (or 2 degree or other degrees) of the motor 211, reading and recording the input position value (D_in) and the output position value (D_Out) after waiting for the preset time, and increasing the count by 1 until the count is greater than the data amount.

Thus, obtaining, by the error compensation calculation circuit of the compensation module, the position compensation value and the speed compensation value comprises: obtaining, by an amplitude and phase calculation circuit of the compensation module, an error cosine product average value and an error sine product average value of the flex spline according to number of teeth of the flex spline, the ATE table, a position index of the motor, and a total count of the position index; obtaining, by the amplitude and phase calculation circuit, the amplitude and the phase of the flex spline according to the error cosine product average value and the error sine product average value of the flex spline; obtaining, by the amplitude and phase calculation circuit, an error cosine product average value and an error sine product average value of the circular spline according to number of teeth of the circular spline, the ATE table, the position index of the motor, and the total count of the position index; and obtaining, by the amplitude and phase calculation circuit, the amplitude and the phase of the circular spline according to the error cosine product average value and the error sine product average value of the circular spline.

Additionally, the number of teeth of the circular spline has two more teeth than the number of teeth of the flex spline.

A control system of a robotic arm comprises assembled information(s) relating to reducer(s) with the ATE(s), and the control system comprises a control loop configured to adjust control information(s) of the robotic arm according to the assembled information(s) and the ATE(s) of the reducer(s). Wherein a first adjustment is match to a first assembled information to compensate a first ATE coupled to the robotic arm, a second adjustment is match to a second assembled information to compensate a second ATE coupled to the robotic arm.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A control method of a robotic arm, comprising:
deploying a reducer including an assembled construction and an angle transmission error (ATE); and
deploying a control system to control the robotic arm according to the assembled construction and the ATE.

2. The control method of the robotic arm of claim 1, wherein a joint module of the robotic arm comprises the reducer, a motor and a position encoder, and the reducer comprises a flex spline and a circular spline,
wherein the control method further comprising:
reading, by a compensation module, a motor position and a motor speed of the motor from the position encoder;
obtaining, by an error compensation calculation circuit of the compensation module, a position compensation value according to an ATE table stored in a storage circuit of the compensation module, a phase and an amplitude of the flex spline, a phase and an amplitude of the circular spline, and the motor position;
obtaining, by the error compensation calculation circuit, a speed compensation value according to the ATE table, the phase and the amplitude of the flex spline, the phase and the amplitude of the circular spline, the motor position and the motor speed; and
inputting, by the compensation module, the position compensation value and the speed compensation value to a control loop coupled to the joint module, to compensate for control of the joint module.

3. The control method of the robotic arm of claim 2, wherein the joint module comprises an output-node encoder coupled to the reducer, configured to indicate an output position value of the joint module.

4. The control method of the robotic arm of claim 3, wherein the ATE table is generated by following steps:
reading, by a learning controller, a reduction ratio of the joint module related to a number of teeth of the flex spline and number of teeth of the circular spline;
resetting, by the learning controller, a count of a counter, and setting a rotation status of the joint module to an original position;
calculating, by the learning controller, a data amount related to the reduction ratio;
moving, by a learning controller, 1 degree rotating movement of the joint module, and, after waiting for a preset time, reading and recording an input position value of the position encoder and the output position value of the output-node encoder;
increasing, by the learning controller, the count by 1, and determining whether the count is greater or equal to the data amount; and
calculating, by the learning controller, the ATE table according to the input position value, the output position value, and the reduction ratio, and storing the ATE table in the storage circuit of the compensation module, when the count is greater or equal to the data amount; or
when the count is less than the data amount, moving, by the learning controller, repeatedly 1 degree rotating movement of the joint module, reading and recording the input position value of the position encoder and the output position value of the output-node encoder after waiting for the preset time, and increasing the count by 1 until the count is greater than the data amount.

5. The control method of the robotic arm of claim 2, wherein obtaining, by the error compensation calculation circuit of the compensation module, the position compensation value and the speed compensation value comprises:
obtaining, by an amplitude and phase calculation circuit of the compensation module, an error cosine product average value and an error sine product average value of the flex spline according to number of teeth of the flex spline, the ATE table, a position index of the motor, and a total count of the position index;
obtaining, by the amplitude and phase calculation circuit, the amplitude and the phase of the flex spline according to the error cosine product average value and the error sine product average value of the flex spline;
obtaining, by the amplitude and phase calculation circuit, an error cosine product average value and an error sine product average value of the circular spline according to number of teeth of the circular spline, the ATE table, the position index of the motor, and the total count of the position index; and
obtaining, by the amplitude and phase calculation circuit, the amplitude and the phase of the circular spline according to the error cosine product average value and the error sine product average value of the circular spline,
wherein the number of teeth of the circular spline has two more teeth than the number of teeth of the flex spline in the assembled construction.

6. A compensation module, comprising:
a storage circuit, configured to store an ATE table;
an amplitude and phase calculation circuit, configured to obtain an amplitude and a phase of a flex spline, and an amplitude and a phase of a circular spline of a reducer; and
an error compensation calculation circuit, configured to read a motor position and a motor speed of a motor from the position encoder, to obtain a position compensation value according to the ATE table, the amplitude and the phase of the flex spline, and the amplitude and the phase of the circular spline, and the motor position, and obtain a speed compensation value according to the ATE table, the amplitude and the phase of the flex spline, and the amplitude and the phase of the circular spline, the motor position, and the motor speed,
wherein the compensation module transmits the position compensation value and the speed compensation value to a control loop of a robotic arm, to compensate a control of the joint module for the robotic arm.

7. The compensation module of claim 6, wherein the joint module comprises an output-node encoder coupled to the reducer, configured to indicate an output position value of the joint module.

8. The compensation module of claim 7, wherein the ATE table is generated by:
a learning controller coupled to the control loop reading a reduction ratio of the joint module related to a number of teeth of the flex spline and number of teeth of the circular spline;
the learning controller resetting a count of a counter, and setting a rotation status of the joint module to an original position;
the learning controller calculating a data amount related to the reduction ratio;
the learning controller moving 1 degree rotating movement of the joint module, and, after waiting for a preset time, reading and recording an input position value of the position encoder and the output position value of the output-node encoder;
the learning controller increasing the count by 1, and determining whether the count is greater or equal to the data amount; and
the learning controller calculating the ATE table according to the input position value, the output position value, and the reduction ratio, and storing the ATE table in the storage circuit of the compensation module, when the count is greater or equal to the data amount; or
when the count is less than the data amount, the learning controller moving repeatedly 1 degree rotating movement of the joint module, reading and recording the input position value of the position encoder and the output position value of the output-node encoder after waiting for the preset time, and increasing the count by 1 until the count is greater than the data amount.

9. The compensation module of claim 6, wherein the amplitude and phase calculation circuit obtaining the amplitude and the phase of the flex spline, and the amplitude and the phase of the circular spline executes the following operations:
obtaining an error cosine product average value and an error sine product average value of the flex spline according to number of teeth of the flex spline, the ATE table, a position index of the motor, and a total count of the position index;
obtaining the amplitude and the phase of the flex spline according to the error cosine product average value and the error sine product average value of the flex spline;
obtaining an error cosine product average value and an error sine product average value of the circular spline according to number of teeth of the circular spline, the ATE table, the position index of the motor, and the total count of the position index; and
obtaining, by the amplitude and phase calculation circuit, the amplitude and the phase of the circular spline according to the error cosine product average value and the error sine product average value of the circular spline,
wherein the number of teeth of the circular spline has two more teeth than the number of teeth of the flex spline.

10. A control system of a robotic arm, comprising:
an assembled construction, relating to a reducer with an angular transmission error (ATE); and
a control loop, configured to adjust a control information of the robotic arm according to the assembled construction and the ATE of the reducer, wherein a first adjustment is match to a first assembled information to compensate a first ATE coupled to the robotic arm, a second adjustment is match to a second assembled information to compensate a second ATE coupled to the robotic arm.
